(19) United States
(12) Patent Application Publication
(10) Pub. No.: US 2008/0217214 A1
(43) Pub. Date: Sep. 11, 2008

(54) Papermaking screen device

(75) Inventor: Yoshihiko Aikawa, Shizuoka-shi (JP)

Correspondence Address: KANESAKA BERNER AND PARTNERS LLP, 1700 DIAGONAL RD, SUITE 310, ALEXANDRIA, VA, 22314-2848, US

(73) Assignee: AIKAWA IRON WORKS CO., LTD., Shizuoka-shi (JP)

(21) Appl. No.: 12/073,190

(22) Filed: Mar. 3, 2008

(30) Foreign Application Priority Data
Mar. 8, 2007 (JP) 2007-58555

(51) Int. Cl. B07B 1/22

(52) U.S. Cl. 209/270

(57) ABSTRACT

A papermaking screen device includes a tank for receiving a papermaking material, the tank having an inlet, a refining outlet, a foreign material outlet, a first chamber and a second chamber formed outside the first chamber; a cylindrical screen provided inside the tank and dividing the tank into the first and second chambers so that the first chamber is formed inside the cylindrical screen, and the second chamber is formed outside the cylindrical screen, the cylindrical screen having a cylindrical shape and opening portions on an lateral side of the cylindrical screen; an agitating member provided in the first chamber; and a vibration member contacting the cylindrical screen for vibrating the cylindrical screen in such a range that the cylindrical screen does not contact the agitating member. The inlet and the foreign material outlet face the first chamber, and the refining outlet faces the second chamber.

### BACKGROUND OF THE INVENTION AND RELATED ART STATEMENT

The present invention relates to a papermaking screen device, especially, a papermaking screen device that improves processing capacity.

Conventionally, there is, for example, a screen provided with a rotating blade (agitating member) provided inside a screen basket (cylindrical screen) (for example, refer to FIG. 16 in Japanese Patent No. 3190254).

In the above-mentioned screen, in front of the rotating blade (agitating member), a positive pressure is applied to the screen basket (cylindrical screen); and at a back side of the rotating blade (agitating member), a negative pressure is applied to the screen basket (cylindrical screen), so that a cleaning operation of the screen basket (cylindrical screen) is automatically and regularly conducted.

However, even by this cleaning operation, a papermaking material is accumulated at an inlet side of the screen basket (cylindrical screen). Accordingly, due to the above-mentioned factor, a processing capacity cannot be improved.

The purpose of the present invention is to provide a papermaking screen device to solve the above-mentioned problem.

Further objects and advantages of the invention will be apparent from the following description of the invention.

### SUMMARY OF INVENTION

A papermaking screen device in the present invention includes an inlet portion, a refining outlet portion, and a foreign material outlet portion for a papermaking material. The papermaking screen device is also provided with a tank for receiving the papermaking material; a cylindrical screen provided inside the tank, dividing the tank into a first chamber and a second chamber, and including an open ceiling, an open bottom, and an opening on a lateral side of the cylindrical screen; an agitating member provided in the first chamber which is located inside the cylindrical screen; and a vibration member contacting the cylindrical screen for vibrating the cylindrical screen in such a range that the cylindrical screen does not contact the agitating member. The inlet portion and the foreign material outlet portion face the first chamber, and the refining outlet portion faces the second chamber.

In the papermaking screen device according to the first aspect of the invention, the papermaking screen device according to a second aspect of the invention includes projections projecting to the outer periphery of the cylindrical screen; a supporting member provided inside the tank and supporting the projection; and a vibration damper placed between the supporting member and the projection.

The papermaking screen device according to a third aspect of the invention includes the inlet portion, the refining outlet portion, and the foreign material outlet portion for the papermaking material. The papermaking screen device is also provided with the tank for receiving the papermaking material; the cylindrical screen provided inside the tank and dividing the tank into the first chamber and the second chamber, the cylindrical screen including a closed ceiling, an open bottom and the opening on the lateral side of the cylindrical screen; the agitating member provided inside the second chamber located outside the cylindrical screen; and the vibration member contacting the cylindrical screen for vibrating the cylindrical screen in such a range that the cylindrical screen does not contact the agitating member. The inlet portion and the foreign material outlet portion face the second chamber, and the refining outlet portion faces the first chamber.

In the papermaking screen device according to the third aspect of the invention, the papermaking screen device according to a fourth aspect of the invention includes an inward projection located at the lower end of the cylindrical screen and projecting to a center of the cylindrical screen at the lower end; the supporting member provided inside the tank and supporting the inward projection; and the vibration damper placed between the supporting member and the inward projection.

In the papermaking screen device according to the first aspect of the invention, the cylindrical screen is vibrated and this vibration is in such a range that the cylindrical screen does not contact the agitating member which is located inside. As a result, damage on the cylindrical screen caused by the agitating member can be prevented. In addition to the cleaning operation of the screen conducted by the agitating member, fluidity is applied to the papermaking material accumulated on the cylindrical screen, so that the processing capacity can be improved.

Also, according to the papermaking screen device of the third aspect, the cylindrical screen is vibrated, and this vibration is in such a range that the cylindrical screen does not contact the agitating member located outside. As a result, the damage on the cylindrical screen caused by the agitating member can be prevented. In addition to the cleaning operation of the screen conducted by the agitating member, fluidity is applied to the papermaking material accumulated on the cylindrical screen, so that the processing capacity can be improved.

### BRIEF DESCRIPTION OF THE DRAWINGS

FIG. 1 is a schematic cross sectional view of a papermaking screen device of the first embodiment of the present invention;

FIG. 2 is a schematic cross sectional view taken along line 2-2 in FIG. 1;

FIG. 3 is a partially enlarged sectional view wherein a portion in FIG. 1 is enlarged;

FIG. 4 is a partially enlarged sectional view wherein a portion in FIG. 1 is enlarged;

FIG. 5 is a schematic cross sectional view of the papermaking screen device of another embodiment of FIG. 1;

FIG. 6 is a schematic cross sectional view taken along line 6-6 in FIG. 5;

FIG. 7 is a schematic partially enlarged sectional view wherein a portion in FIG. 5 is enlarged;

FIG. 8 is a schematic cross sectional view of the papermaking screen device of another embodiment of FIG. 5;

FIG. 9 is a schematic partially enlarged cross sectional view wherein a portion in FIG. 8 is enlarged; and

FIG. 10 is a schematic cross sectional view of the papermaking screen device of another embodiment of FIG. 8.

### DETAILED DESCRIPTION OF PREFERRED EMBODIMENTS

Embodiments of a papermaking screen device of the present invention will be explained with reference to the drawings.

### Embodiment 1

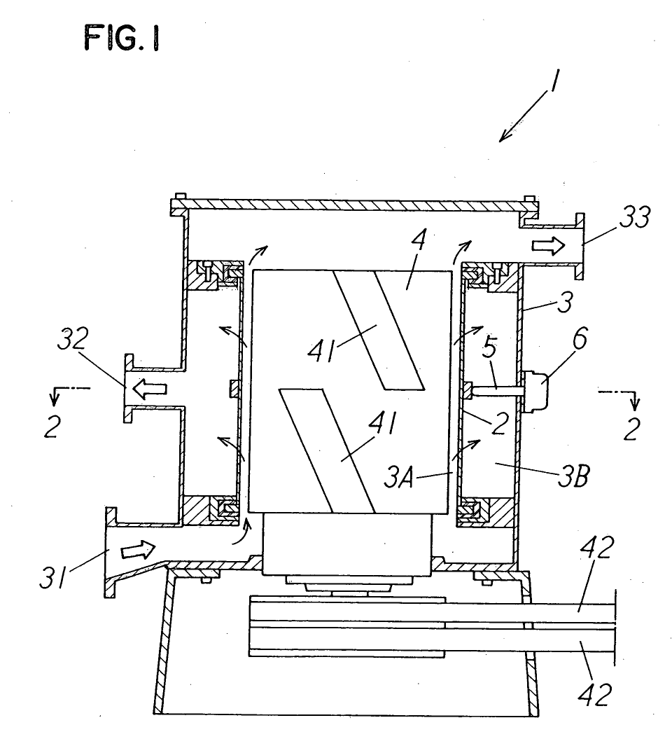

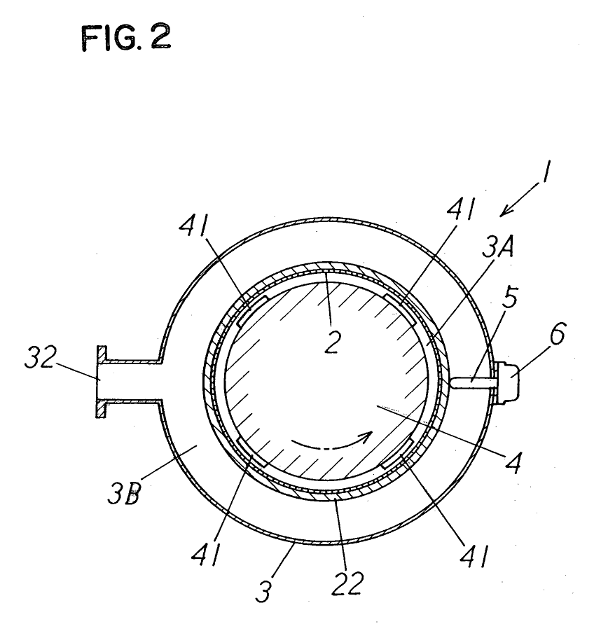

In FIGS. 1-4, the reference numeral 1 represents the papermaking screen device, and the papermaking screen device 1 is, for example, a screen device for flowing a papermaking material toward the outside of a screen from the inside of the screen, and refining the papermaking material. A cylindrical screen 2 is provided inside a tank 3 for eliminating dust and a foreign material in the papermaking material.

The tank 3 receives the papermaking material to be processed. The tank 3 includes an inlet portion 31, a refining outlet portion 32, and a foreign material outlet portion 33 for the papermaking material. The inlet portion 31 is connected to a material supply pipe (not shown), the refining outlet portion 32 is connected to a material discharge pipe (not shown), and the foreign material outlet portion 33 is connected to a foreign material discharge pipe (not shown), respectively. Incidentally, the refined papermaking material which is discharged from the material discharge pipe (not shown) is led to another process, and a valve (not shown) which opens and closes a passage of the foreign material discharge pipe (not shown) is provided in the middle of the foreign material discharge pipe (not shown) connected to the foreign material outlet portion 33.

The above-mentioned cylindrical screen 2, for example, has an open ceiling and a bottom, and openings 21 such as slits, circular holes and the like on a lateral side of the cylindrical screen 2. The cylindrical screen 2 is provided inside the tank 3 and divides the inside of the tank 3 into a first chamber 3A and a second chamber 3B. Incidentally, the inlet portion 31 and the foreign material outlet portion 33 face the first chamber 3A, and the refining outlet portion 32 faces the second chamber 3B, respectively.

The reference numeral 4 represents an agitating member and the agitating member 4, for example, includes multiple projections 41 on the side face of a cylindrical shape. The agitating member 4 is provided on the first chamber 3A located inside the cylindrical screen 2. Incidentally, the agitating member 4 is designed to be rotated by a rotational force from a motor (not shown) through belts 42.

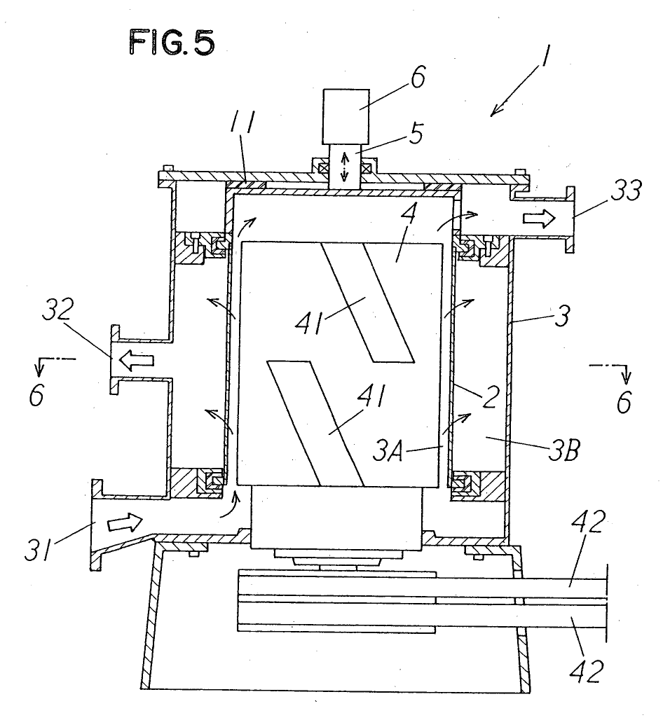

The reference numeral 5 represents a vibration member which contacts the side face of the cylindrical screen 2 and makes the cylindrical screen 2 vibrate in such a range that the cylindrical screen 2 does not contact the agitating member 4. The reference numeral 6 represents a vibratory portion (vibrator) which causes a vibration. As shown in FIG. 4, the end of the vibration member 5 contacts an intermediate projection 22 which projects from the lateral side of the cylindrical screen 2. Incidentally, possibly, the intermediate projection 22 may be omitted, and the end of the vibration member 5 may directly contact the lateral side of the cylindrical screen 2.

On the outer periphery of the cylindrical screen 2, along with the intermediate projection 22, projections 23, 24 (for example, provided in a circular pattern along the outer periphery of the cylindrical screen 2) project from the lateral side of the cylindrical screen 2 at the upper portion and the lower portion, respectively.

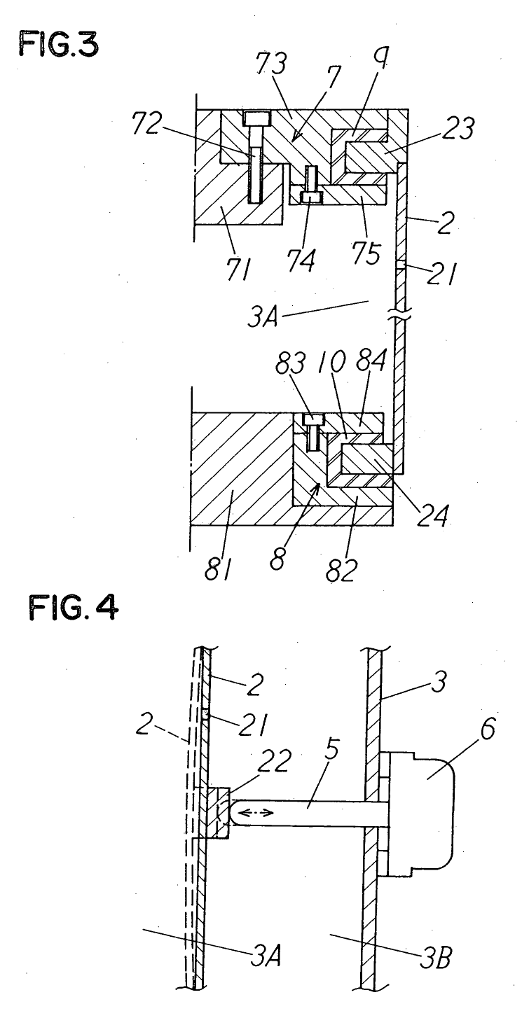

The projections 23, 24 are supported by supporting members 7, 8 which are provided inside the tank 3. A vibration damper 9 (for example, synthetic rubber, synthetic resin, spring, and the like) is placed between the supporting member 7 and the projection 23, and a vibration damper 10 (for example, synthetic rubber, synthetic resin, spring, and the like) is placed between the supporting member 8 and the projection 24, respectively (refer to FIG. 3).

The supporting member 7 includes an upper inner wall supporting member 71 which is connected to the inner wall of the tank 3; an upper first supporting member 73 which is connected to the upper inner wall supporting member 71 through an upper first bolt 72, and includes an inverted L-shaped housing portion which houses the projection 23 on a cylindrical screen 2 side; and an upper second supporting member 75 which is located under the upper first supporting member 73 and connected to the upper first supporting member 73 through a lower first bolt 74.

The supporting member 8 located under the supporting member 7 includes a lower inner wall supporting member 81 connected to the inner wall of the tank 3; a lower first supporting member 82 placed on the lower inner wall supporting member 81, and including a L-shaped housing portion which houses the projection 24 on the cylindrical screen 2 side; and a lower second supporting member 84 located on the lower first supporting member 82 and connected through a bolt 83.

Therefore, in the papermaking screen device 1 shown in FIGS. 1 to 4, when the papermaking material is led to the first chamber 3A through the material supply pipe (not shown) and the inlet portion 31 by a pump (not shown), the cylindrical screen 2 vibrates due to the vibration member 5 on a side of the cylindrical screen 2, where papermaking material flows in, due to an interaction of an application of a positive pressure and a negative pressure by the cylindrical screen 2 and the projections 41 of the agitating member 4, in addition to a cleaning operation of the cylindrical screen 2. Accordingly, the papermaking material accumulated on the cylindrical screen 2 increases fluidity, so that the processing capacity can be improved.

Incidentally, the vibration of the cylindrical screen 2 caused by the vibration member 5 is in such a range that the cylindrical screen 2 does not contact the projections 41 of the agitating member 4 located inside. As a result, the projections 41 of the agitating member 4 do not cause damage to the cylindrical screen 2. Also, the vibration of the cylindrical screen 2 is not transmitted to the tank 3 due to the vibration dampers 9, 10.

Material fibers, passing through the opening portion 21 of the cylindrical screen 2, are led into the second chamber 3B, and out of the tank 3 through the refining outlet portion 32. Incidentally, the valve (not shown) of the foreign material discharge pipe (not shown) which is connected to the foreign material outlet portion 33 is opened arbitrarily, so that the foreign material inside the first chamber 3A can be discharged to the tank 3.

### Embodiment 2

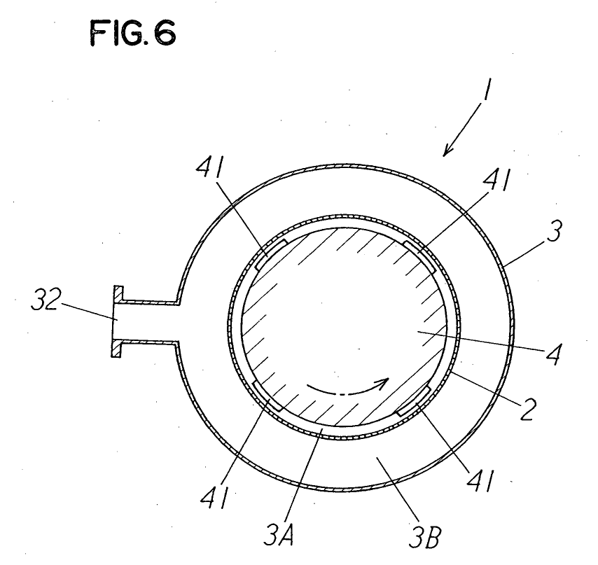

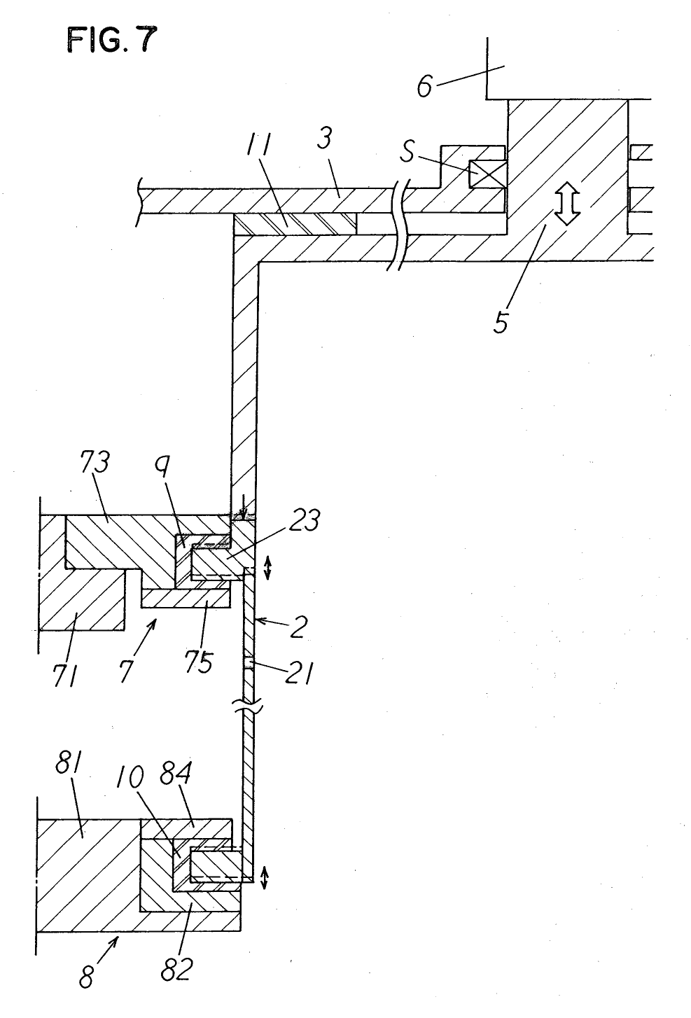

The vibration of the vibration member 5 of the papermaking screen device 1 shown in FIGS. 1 to 4 is in a horizontal direction. However, the present invention is not limited to the above-mentioned direction. For example, as shown in FIGS. 5 to 7, the cylindrical screen 2 may be vibrated in a vertical direction.

This embodiment is the same as the above-mentioned embodiment except that the vibrator 6 which generates the vibration is located on a ceiling portion of the tank 3, and that the vibration member 5 contacts the ceiling portion of the cylindrical screen 2. Accordingly, in this embodiment, the same symbols are assigned to the same or corresponding parts of the papermaking screen device 1 shown in FIGS. 1 to 4, and their explanations are omitted.

Incidentally, the reference alphabet S represents a seal material for sealing the vibration member 5, and the reference numeral 11 represents a vibration damper such as a synthetic rubber, synthetic resin, spring, and the like.

### Embodiment 3

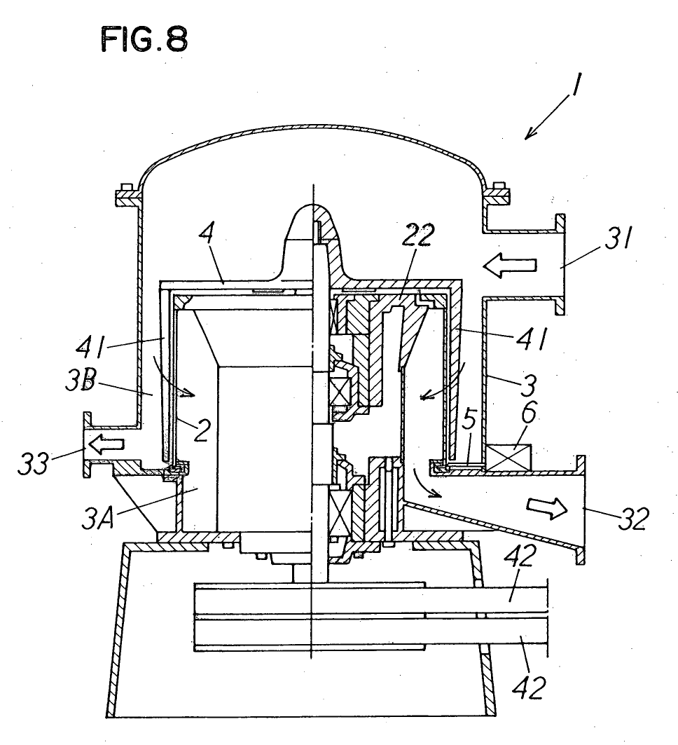

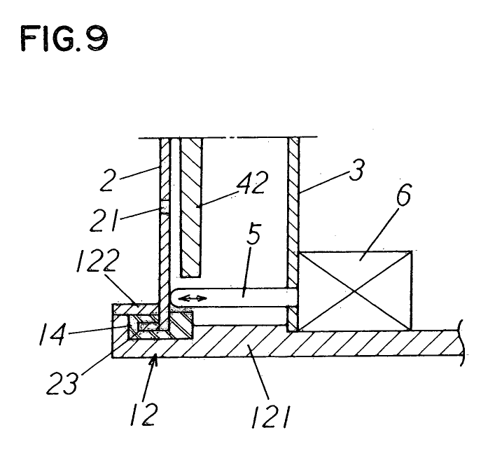

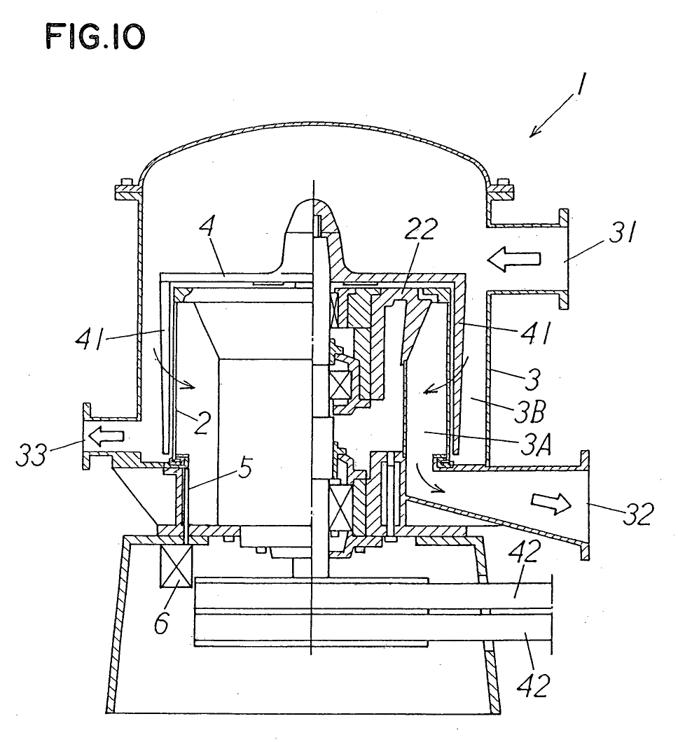

The papermaking screen device shown in FIGS. 1 to 7 is the screen device for making the papermaking material flow from the inside of the screen toward the outside of the screen. However, the invention is not limited to the above-mentioned papermaking screen device. For example, as shown in FIGS. 8, 9, even the screen, which refines the papermaking material by making the papermaking material flow from the outside of the screen to the inside of the screen, may be applied in a similar fashion and the cylindrical screen 2 may be vibrated.

More specifically, the tank 3 receiving the papermaking material includes the inlet portion 31, the refining outlet portion 32, and the foreign material outlet portion 33 for the papermaking material. The inlet portion 31 is connected to the material supply pipe (not shown), the refining outlet portion 32 is connected to the material discharge pipe (not shown), and the foreign material outlet portion 33 is connected to the foreign material discharge pipe (not shown), respectively. Incidentally, the refined papermaking material which is discharged from the material discharge pipe (not shown) is led to another process, and the valve (not shown) which opens and closes the passage of the foreign material discharge pipe (not shown) is provided in the middle of the foreign material discharge pipe (not shown) connected to the foreign material outlet portion 33.

The cylindrical screen 2, having the openings such as the slits, circular holes and the like on the lateral side, is provided inside the tank 3 and divides the inside of the tank 3 into the first chamber 3A and the second chamber 3B. A ceiling 22 of the cylindrical screen 2 is closed. However, the bottom portion is open and communicating with the refining outlet portion 32.

The agitating member 4 located outside the cylindrical screen 2 is provided inside the second chamber 3B, and the inlet portion 31 and the foreign material outlet portion 33 face the second chamber 3B and the refining outlet portion 32 faces the first chamber 3A, respectively. The vibration member 5, making the cylindrical screen 2 vibrate, contacts the cylindrical screen 2 for vibrating the cylindrical screen 2 (for example, vibrate in a horizontal direction as shown in FIGS. 8, 9, or in a vertical direction as shown in FIG. 10) in such a range that the cylindrical screen 2 does not contact the projections 41 of the agitating member 4. The reference numeral 6 represents the vibrator generating the vibration to the vibration member 5 as in the case of the above-mentioned embodiment.

The reference numeral 23 shown in FIG. 9 is an inward projection inwardly projecting at the lower end of the cylindrical screen 2. The inward projection 23 is supported by a supporting member 12 provided inside the tank 3.

The supporting member 12 is connected to the inner wall of the tank 3 and includes a lower inner wall supporting member 121 including a housing portion housing the inward projection 23;

and a supporting member 122 located on the lower inner wall supporting member and connected through the bolt (not shown). The reference numeral 14 represents the vibration damper such as synthetic rubber, synthetic resin, spring, and the like provided between the supporting member 12 and the inward projection 23.

In the embodiment, the same symbols are assigned to the same or corresponding parts of the papermaking screen device 1 shown in FIGS. 1 to 4, and their explanations are omitted.

The disclosure of Japanese Patent Application No. 2007-058555, filed on Mar. 8, 2007, is incorporated in the application.

While the invention has been explained with reference to the specific embodiments of the invention, the explanation is illustrative and the invention is limited only by the appended claims.

What is claimed is:

1. A papermaking screen device, comprising:
a tank for receiving a papermaking material, the tank including an inlet, a refining outlet, a foreign material outlet, a first chamber and a second chamber formed outside the first chamber;
a cylindrical screen provided inside the tank and dividing the tank into the first and second chambers so that the first chamber is formed inside the cylindrical screen, the cylindrical screen having opening portions for flowing the papermaking material therethrough;
an agitating member provided in the tank adjacent the cylindrical screen for agitating the papermaking material; and
a vibration device attached to the cylindrical screen for vibrating the cylindrical screen in such a range that the cylindrical screen does not contact the agitating member.

2. A papermaking screen device according to claim 1, wherein the vibrating device includes a vibrator formed outside the screen, and a vibration member connected between the cylindrical screen and the vibrator so that when the vibrator is operated, the cylindrical screen vibrates vertically or horizontally.

3. A papermaking screen device according to claim 2, further comprising projections projecting from the cylindrical screen, supporting members provided inside the tank and supporting the projections, and vibration dampers provided between the supporting members and the projections so that vibration of the screen is damped.

4. A papermaking screen device according to claim 3, wherein the agitating member is provided inside screen, the inlet and the foreign material outlet face the first chamber, and the refining outlet faces the second chamber.

5. A papermaking screen device according to claim 4, wherein the cylindrical screen further includes an intermediate projection provided at a substantially center thereof, and attached to the vibration member to vibrate the cylindrical screen through the intermediate projection.

6. A papermaking screen device according to claim 4, wherein the projections project to an outer periphery of the cylindrical screen.

7. A papermaking screen device according to claim 3, wherein the agitating member is provided in the second chamber, the inlet and the foreign material outlet face the second chamber, and the refining outlet faces the first chamber.

8. A papermaking screen device according to claim 7, wherein the projections are located at a lower end of the cylindrical screen and project inward at the lower end.
